(19) United States
(12) Patent Application Publication
(10) Pub. No.: US 2014/0127569 A1
(43) Pub. Date: May 8, 2014

(54) COPPER FOIL PROVIDED WITH CHROMATE FILM FOR NEGATIVE ELECTRODE CURRENT COLLECTOR, AND NEGATIVE ELECTRODE MATERIAL USING THE COPPER FOIL PROVIDED WITH CHROMATE FILM FOR NEGATIVE ELECTRODE CURRENT COLLECTOR

(71) Applicants: Tomoyuki Maeda, Saitama (JP); Sakiko Tomonaga, Tokyo (JP); Yasunori Tabira, Saitama (JP)

(72) Inventors: Tomoyuki Maeda, Saitama (JP); Sakiko Tomonaga, Tokyo (JP); Yasunori Tabira, Saitama (JP)

(73) Assignee: MITSUI MINING & SMELTING CO., LTD., Tokyo (JP)

(21) Appl. No.: 14/110,778

(22) PCT Filed: Apr. 10, 2012
(86) PCT No.: PCT/JP2012/059805

§ 371 Date: Jan. 15, 2014

(30) Foreign Application Priority Data
Apr. 12, 2011 (JP) 2011-088510

(51) Int. Cl. H01M 4/66

(52) U.S. Cl. CPC H01M 4/665
USPC 429/211

(57) ABSTRACT

An object of the present invention is to eliminate deviation in the quality of a chromate film provided on a copper foil for a negative electrode current collector to eliminate fluctuation of electric capacity in a lithium ion secondary battery.

To achieve the object, as the copper foil for a negative electrode current collector of a lithium ion secondary battery, a copper foil provided with a chromate film for a negative electrode current collector in which Cr(OH)₃ constitutes 85 area % or more of the chromate film is employed. Further, the copper foil provided with a chromate film for a negative electrode current collector according to the present application is preferable to be that the apparent orientation number N of oxygen closest to chrome in the chromate film is 4.5 or more.

### TECHNICAL FIELD

The present invention relates to a copper foil provided with a chromate film for a negative electrode current collector. In particular, the present invention relates to the copper foil provided with a chromate film for a negative electrode current collector suitable for a negative electrode material of a lithium ion secondary battery.

### BACKGROUND ART

Copper foil has been widely used for a negative electrode current collector used in manufacturing of a negative electrode of a lithium ion secondary battery. When a copper foil surface used for a negative electrode current collector is oxidized, a reduction of oxide at the copper foil surface may occur in a charging process, and the reduction consumes lithium in a lithium ion secondary battery. Therefore, it is known that the oxide exists on a copper foil surface reduces an electric capacity of a lithium ion secondary battery. In order to solve the problem, various inventions including applying of chromate treatment on the copper foil surface have been proposed.

For example, Patent Document 1 (Japanese Patent Laid-Open No. 11-158652) discloses the manufacturing of a copper foil provided with a chromate film on the surface through “a method for manufacturing a copper foil used for an electrode of a secondary battery, wherein rust-proofing treatment on a surface of the copper foil is carried out with an alkaline chromate bath” to provide a negative electrode current collector of a secondary battery having good rust-proofing performance and achieves sufficient adhesion under an electrolytic solution, and further a long-term charging/discharging cycle is ensured.

Patent Document 2 (Japanese Patent Laid-Open No. 2005-63764) discloses “a copper foil for a lithium ion secondary battery, wherein the copper foil for a lithium ion secondary battery has a chromium-based film formed on the surface, and the chromium in the chromium-based film is composed of trivalent chromium” and “a method for manufacturing a copper foil for a lithium ion secondary battery, including: cathodically electrolyzing rolled copper foil in an aqueous solution containing trivalent chromium ions to form a chromium-based film on a surface of the copper foil” employed to provide a negative electrode current collector for a lithium ion secondary battery which prevents the dissolution of copper at over-discharging and can prevent the oxidation of the copper foil in the battery manufacturing process without hexavalent chromate treatment.

Further, object of the invention disclosed in Patent Document 3 (Japanese Patent Laid-Open No. 2009-68042) is to provide a copper foil excellent in ultrasonic weld-ability when the copper foils are joined to each other or the copper foil is joined to other metal by ultrasonic welding, and to provide a surface treatment method of the copper foil. Disclosures in Patent Document 3 are that “A copper foil at least one surface of which is provided with a chromium hydrous oxide layer, wherein the coating amount of the chromium hydrous oxide layer on the surface of the copper foil is 0.5 to 70 μg-Cr/dm². A surface treatment method of copper foil excellent in ultrasonic weld-ability includes immersing of copper foil in an aqueous chromic acid solution prepared by dissolving at least one of hexavalent chromium compounds in water to coat the copper foil surface with a chromium hydrous oxide layer. A surface treatment method of copper foil excellent in ultrasonic weld-ability includes electrolytically treating copper foil with an aqueous chromic acid electrolytic solution prepared by dissolving at least one of hexavalent chromium compounds in water to coat the copper foil surface with a chromium hydrous oxide layer.” That is, the invention disclosed in Patent Document 3 directs to “a copper foil at least one surface of which is provided with a chromium hydrous oxide layer”.

Furthermore, Patent Document 4 (Japanese Patent Laid-Open No. 2008-117655) discloses “a negative electrode current collector used for the negative electrode of a nonaqueous electrolyte secondary battery has copper foil and a rust-proofing layer formed on a surface of the copper foil, wherein the rust-proofing layer contains a metal element such as nickel, chromium, zinc, and indium; the metal element is contained in the rust-proofing layer as a hydroxide; and the negative electrode is heat-treated in an inert gas.” to provide a negative electrode current collector for a nonaqueous electrolyte secondary battery which is excellent and stable in the battery charging/discharging, and a nonaqueous electrolyte secondary battery using the same. Then, Examples 1 to 3, Example 15, and Example 16 of Patent Document 4 disclose that the rust-proofing layer is obtained by chromate treatment.

As described above, oxidation of the copper foil surface has been hindered by providing chromate treatment on the surface of copper foil used for a negative electrode current collector to effectively prevent the decline in electric capacity of a lithium ion secondary battery.

### DOCUMENTS CITED

### Patent Documents

### [Patent Document 1]

Japanese Patent Laid-Open No. 11-158652

### [Patent Document 2]

Japanese Patent Laid-Open No. 2005-63764

### [Patent Document 3]

Japanese Patent Laid-Open No. 2009-68042

### [Patent Document 4]

Japanese Patent Laid-Open No. 2008-117655

### SUMMARY OF THE INVENTION

### Problems to be Solved

However, even if the chromate treated copper foil is used for the negative electrode current collector of a lithium ion secondary battery, decline in electric capacity of a lithium ion secondary battery could not be sometimes effectively hindered. The matter is supposed due to the deviation in the quality of a chromate film formed by conventional chromate treatment, and the deviation in the chromate film causes the fluctuation of electric capacity in a lithium ion secondary battery.

The fluctuation of electric capacity in a lithium ion secondary battery resulting from the quality deviation of the chromate film may not a big problem in application for a household electrical appliance. However, as for a battery for automotive use mounted on an electric vehicle and a hybrid electric vehicle, the fluctuation of electric capacity may cause a big difference from design quality and the difference might be an important factor that affects on the mileage and running stability of the vehicles on which the battery is mounted.

Therefore, it has been desired to eliminate the quality deviation of chromate films provided on the copper foil for a negative electrode current collector in order to eliminate the fluctuation of electric capacity in a lithium ion secondary battery.

### Means to Solve the Problem

Thus, as a result of intensive and extensive researches, the present inventors have thought out the matter that selective adopting of a copper foil provided with a chromate film described below stably hinders the oxidation of the copper foil surface when the copper foil is used for a negative electrode current collector and the decline in electric capacity of a lithium ion secondary battery caused by presence of oxide on the copper foil surface is stably hindered.

Copper foil provided with a chromate film for a negative electrode current collector: The copper foil provided with a chromate film for a negative electrode current collector according to the present application is a copper foil provided with a chromate film used as a negative electrode material of a lithium ion secondary battery, wherein 85 area % or more of the chromate film is composed of chromium hydroxide (hereinafter represented by “Cr(OH)₃”). Note that the unit indicated by “area %” here will be explained later in detail.

Next, the copper foil provided with a chromate film for a negative electrode current collector according to the present application is preferable that the apparent orientation number N of oxygen closest to chrome in the chromate film obtained by XAFS analysis of the chromate film is 4.5 or more.

Further, the copper foil provided with a chromate film for a negative electrode current collector according to the present application is preferable that the height of a normalized pre-edge peak of a chromium K absorption edge XAFS spectrum of the chromate film is 0.08 or less.

The copper foil provided with a chromate film for a negative electrode current collector according to the present application is preferable that the deposition amount in terms of chromium in the chromate film is 1.0 mg/m² to 3.9 mg/m².

Negative electrode material: The negative electrode material of a lithium ion secondary battery according to the present application is characterized in that the negative electrode active material layer is provided on one surface or both surfaces of any one of the copper foil provided with a chromate film for a negative electrode current collector described above.

### Advantages of the Invention

As the copper foil provided with a chromate film for a negative electrode current collector according to the present application is provided with a chromate film having a specific composition and a specific deposition structure described above, oxidation of a copper foil surface is hindered to make amount of the oxide exists on the copper foil surface minimum. Therefore, when the copper foil provided with a chromate film for a negative electrode current collector according to the present application is used for the negative electrode material of a lithium ion secondary battery, as amount of the oxide exists on the copper foil surface is minimum, the consumption of lithium by the reduction of the oxide exists on the copper foil surface in a charging process of a lithium ion secondary battery can be hindered, and decline in electric capacity of a lithium ion secondary battery is made minimum.

### BRIEF DESCRIPTION OF DRAWINGS

FIG. 1 is a diagram illustrating the judgment good or bad in the oxidation resistance according to the relation between “the content of Cr(OH)₃ constituting a chromate film” and “the integrated value of the emission intensity of oxygen (GD-OES) (integrated intensity of the oxygen signal) (base line compensated)” of a copper foil provided with a chromate film for a negative electrode current collector.

FIG. 2 is a model diagram schematically illustrating the “ab-initio structure” of Cr(OH)₃ calculated based on the first principle.

FIG. 3 is a diagram illustrating the judgment good or bad in the oxidation resistance according to the relation between “the apparent orientation number N of oxygen closest to chromium” and “the integrated value of the emission intensity of oxygen (GD-OES) (base line compensated)” of a copper foil provided with a chromate film for a negative electrode current collector.

FIG. 4 is an XAFS spectrum of a specimen in which a pre-edge peak was observed to demonstrate the observation state of the pre-edge peak in the XAFS spectrum of a chromate film.

FIG. 5 is a diagram illustrating the judgement good or bad in the oxidation resistance according to the relation between “the height of a normalized pre-edge peak” and “the integrated value of the emission intensity of oxygen (GD-OES) (base line compensated)” of a copper foil provided with a chromate film for a negative electrode current collector.

FIG. 6 is a diagram demonstrating a method for determination of amount of the oxide at a surface of a copper foil provided with a chromate film for a negative electrode current collector by GD-OES.

### PREFERRED EMBODIMENTS OF THE INVENTION

Hereinafter, embodiments of a copper foil provided with a chromate film for a negative electrode current collector according to the present invention, embodiments of method for manufacturing a copper foil provided with a chromate film for a negative electrode current collector, and embodiments of a negative electrode current collector of a lithium ion secondary battery using the copper foil provided with a chromate film for a negative electrode current collector will be described in turn.

<Embodiments of a Copper Foil Provided with a Chromate Film for Negative Electrode Current Collector>

The copper foil provided with a chromate film for a negative electrode current collector according to the present application is a copper foil provided with a chromate film used as a negative electrode current collector of a lithium ion secondary battery. The copper foil provided with a chromate film is characterized by the following features.

Content of Cr(OH)₃ constituting the chromate film: The chromate film as described herein is characterized by that Cr(OH)₃ constitutes 85 area % or more of the chromate film. This is because, when content of Cr(OH)₃ constituting the chromate film is 85 area % or more, oxidation resistance of the copper foil provided with a chromate film for a negative electrode current collector is made stable, and amount of the oxide on a copper foil surface (the amount of copper oxide) is reduced to minimum.

The measurement of the content of Cr(OH)₃ constituting the chromate film is performed by X-ray Photoelectron Spectroscopy (hereinafter referred to only as “XPS” for short). XPS analyze the elements constituting a specimen and the electronic state of the elements by irradiating X-ray on the specimen surface and measuring the energy of photoelectrons generates. Specifically, the content of Cr(OH)₃ constituting the chromate film can be measured as follows. First, Cr 2p 3/2 in reference materials, Ref1 [Cr₂O₃], Ref2 [Cr(OH)₃] and Ref3 [CrO₃] are measured. As reference materials, chromium (III) oxide manufactured by Kanto Chemical Company Inc. (07350-00, Cica guaranteed reagent) was used as Ref1; chromium (III) hydroxide n-hydrate manufactured by Kanto Chemical Company Inc. (07345-01, Cica extra pure (n-hydrate)) was used as Ref2; and chromic (IV) anhydride manufactured by Wako Pure Chemical Industries, Ltd. (031-03235, guaranteed reagent) was used as Ref3.

In measuring of Cr 2p 3/2 on the reagents described above as a reference material respectively, peak tops in spectrums were close to 576.1 eV for Ref1; close to 577.2 eV for Ref2; and close to 578.9 eV for Ref3. Then, the waveform separation was performed on the basis of the three peak top positions; the area ratios were determined for each reference material; and the spectrum shapes of the reference materials were determined. Subsequently, Cr 2p 3/2 of the chromate film on the copper foil provided with a chromate film for a negative electrode current collector as a specimen was measured, followed by waveform separation on the basis of the peak top positions of the reference materials. Further, a composition consists of Ref1, Ref2, and Ref3 as end members was allocated based on the area ratios constituting the three reference materials. The following expression 1 represents this concept. Specifically, (X₁, X₂, X₃) are determined to make Δ minimum against the observed values (y₁, y₂, y₃). In order to take the accuracy of the peak area at this time into consideration, the reciprocal of the square of standard deviation based on the counting statistics was adopted as the weight. The unit of the values determined as described above is referred to as [area %].

$$[ \begin{matrix}{y}_{1} \\ {y}_{2} \\ {y}_{3}\end{matrix} ] = [ \begin{matrix}{A}_{1} & {B}_{1} & {C}_{1} \\ {A}_{2} & {B}_{2} & {C}_{2} \\ {A}_{3} & {B}_{3} & {C}_{3}\end{matrix} ] [ \begin{matrix}{x}_{1} \\ {x}_{2} \\ {x}_{3}\end{matrix} ] + Δ \qquad [ Expression 1 ]$$

### Wherein,

y₁: Area ratio of a 576.1 eV component in the XPS spectrum of a specimen
y₂: Area ratio of a 577.2 eV component in the XPS spectrum of a specimen
y₃: Area ratio of a 578.9 eV component in the XPS spectrum of a specimen
A₁: Area ratio of a 576.1 eV component in the XPS spectrum of Ref1
A₂: Area ratio of a 577.2 eV component in the XPS spectrum of Ref1
A₃: Area ratio of a 578.9 eV component in the XPS spectrum of Ref1
B₁: Area ratio of a 576.1 eV component in the XPS spectrum of Ref2
B₂: Area ratio of a 577.2 eV component in the XPS spectrum of Ref2
B₃: Area ratio of a 578.9 eV component in the XPS spectrum of Ref2
C₁: Area ratio of a 576.1 eV component in the XPS spectrum of Ref3
C₂: Area ratio of a 577.2 eV component in the XPS spectrum of Ref3
C₃: Area ratio of a 578.9 eV component in the XPS spectrum of Ref3
x₁: Composition ratio using Ref1 as an end member
x₂: Composition ratio using Ref2 as an end member
x₃: Composition ratio using Ref3 as an end member
Δ: Distance between an optimum position of composition in a three-component plane using reference materials as end members and an actual measurement value

TABLE 1

| | | | | | Composition using | | | |
|---|---|---|---|---|---|---|---|---|
| | | Cr 2p 3/2 peak area proportion | | | reference materials as | | | |
| | | (area %) | | | end members (area %) | | | |
| | | 576.1 eV | 577.2 eV | 578.9 eV | Ref1 | Ref2 | Ref3 | Δ |
| | | component | component | component | Cr₂O₃ | Cr(OH)₃ | CrO₃ | (area %) |
| Specimen | Example | 33.21 | 54.45 | 12.34 | 4 | 91 | 5 | 0.03 |
| | Specimen 1 | | | | | | | |
| | Example | 30.99 | 61.45 | 7.56 | 0 | 100 | 0 | 2.99 |
| | Specimen 2 | | | | | | | |
| | Example | 34.94 | 59.56 | 5.50 | 0 | 100 | 0 | 1.70 |
| | Specimen 3 | | | | | | | |
| | Example | 33.18 | 52.46 | 14.36 | 6 | 86 | 8 | 0.14 |
| | Specimen 4 | | | | | | | |
| | Comparative | 32.14 | 41.63 | 26.23 | 17 | 59 | 24 | 0.22 |
| | Specimen | | | | | | | |
| | Na₂Cr₂O₇•2H₂O | 4.26 | 9.28 | 86.46 | 0 | 0 | 100 | 0.87 |
| | Na₂CrO₄•4H₂O | 3.86 | 8.60 | 87.54 | 0 | 0 | 100 | 1.19 |
| Reference | Ref1 | 70.93 | 25.77 | 3.30 | 100 | 0 | 0 | — |
| material | Ref2 | 33.30 | 58.03 | 8.67 | 0 | 100 | 0 | — |
| | Ref3 | 1.81 | 11.45 | 86.74 | 0 | 0 | 100 | — |

As shown in Table 1, as the reference material Ref1 [Cr₂O₃] has a broad peak in Cr 2p 3/2, Ref1 has a component to be allocated to the three peak components. That is, it is apparent that the electronic state of each specimen should be determined from the entire peak shape. Further, as the XPS spectrum of a specimen consisting of a plurality of compositions is composed of the superposed electronic states of the compositions constituting the specimen, the composition can be determined based on the spectrum of a single composition proposed. Then, the determined results of the composition ratios on chromate film and chromium compounds through the equation shown as Expression 1 based on a single composition proposed, each reference material of Ref1, Ref2, and Ref3, are shown in the right side of Table 1. From conversion of the spectrum on Na₂Cr₂O₇.2H₂O and Na₂CrO₄.4H₂O which are chromium (VI) compounds, the same type as Ref3, both include Ref3 in an amount of 100 area % and the matter makes reliability of this technology apparent.

Further, actually, the three end members do not always indicate the composition ratio because of a problem of peak resolution and/or the measurement in the excitation state by X-rays. Therefore, the Δ in the equation described in Expression 1 may include an element which may be a source to make indication of the composition ratio by the three end members hard. However, the value shown in Table 1 is as small as 3 area % or less. According to the results, it is apparent that the analysis results of the composition ratios of the specimens determined by this technology are reliable values.

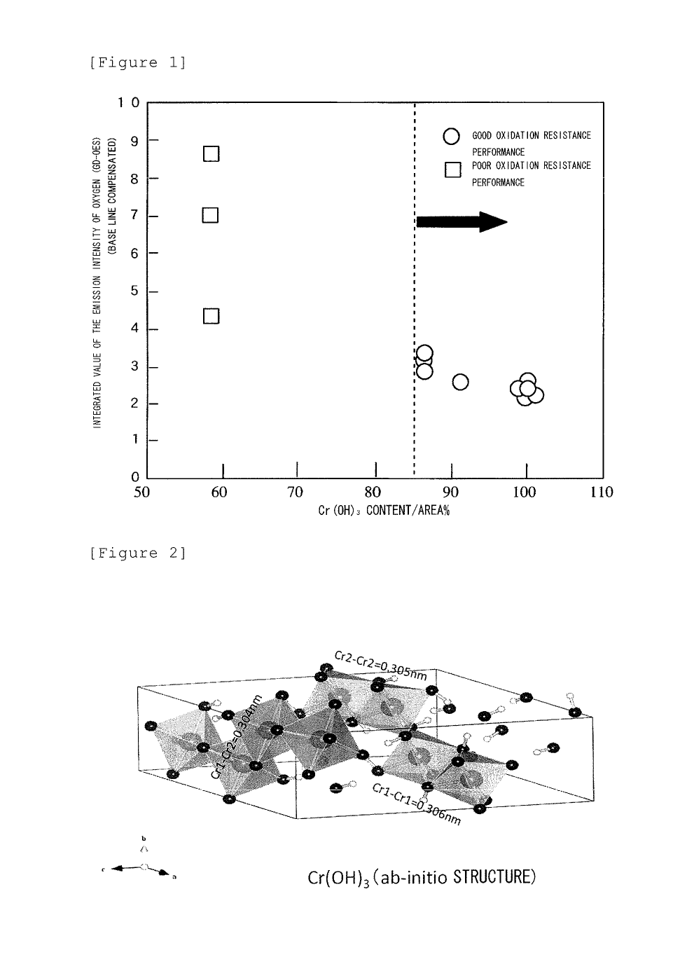

The “content of Cr(OH)₃ constituting a chromate film” has a relationship with an integrated value of the emission intensity of oxygen obtained by using the Glow Discharging Optical Emission Spectrometry (hereinafter referred to as “GD-OES”) in which the base line is compensated, as shown in FIG. 1. In the present application, a region where the integrated value of the emission intensity is 4.5 or less is judged to be a range that is not oxidized. As shown in FIG. 1, a region having good oxidation resistance could be judged a range where the content of Cr(OH)₃ constituting a chromate film is 85 area % or more. GD-OES is a technology in which the emission spectrum generated is measured during etching of a specimen by glow discharging in an argon gas atmosphere.

Apparent orientation number N of oxygen closest to chromium in chromate film: In the copper foil provided with a chromate film for a negative electrode current collector according to the present application, the apparent orientation number N of oxygen closest to chromium obtained by the XAFS analysis is preferable to be 4.5 or more. This is because when the apparent orientation number N of oxygen closest to chromium is 4.5 or more, the oxidation resistance is stable. The words “apparent orientation number N of oxygen closest to chromium” as described herein is a value obtained from the Extended X-ray Absorption Fine Structure (hereinafter only referred to as “EXAFS”) through parameter fitting. EXAFS is a fine structure that appears close to an absorption end by the modulation of a spherical wave through phenomenon that photoelectrons emitted from a certain atom by photoelectric effect is scattered by surrounding atoms to generate a scattered wave and the scattered wave and the original spherical wave interfere with each other in the state where atoms are adjacently located. The basic equation of EXAFS analysis is shown in the following Expression 2.

$$χ ( k ) = {\sum }_{i} {χ}_{i} ( k ) \\ {χ}_{i} ( k ) = {A}_{i} ( k ) \cdot sin ( 2 k {R}_{i} + {δ}_{i} ( k ) ) \\ {A}_{i} ( k ) = {S}_{o}^{2} \cdot {N}_{i} \cdot \vert {f}_{i} ( k , π , R ) \vert \cdot \frac{exp ( - 2 ( {σ}_{i}^{2} {k}^{2} + {R}_{i} / λ ) )}{k {R}_{i}^{2}} \qquad [ Expression 2 ]$$

### Wherein,

k: Wave number of photoelectron
χ(k): EXAFS vibration
i: Number R of shell (set of same type of atoms locate in the equal distance from central atom)
Rᵢ: Distance from central atom to each shell
δᵢ: Phase shift
Nᵢ: Number of atoms in each shell
fᵢ: Back-scattering amplitude of each shell
σᵢ: Debye-Waller factor of each shell
Sₒ: Attenuation factor

Using the basic equation of EXAFS analysis described in Expression 2, parameter fitting was performed on k^{3χ(k)}, EXAFS vibration extracted from experimental data is cubed on k for weighting. At this time, it is necessary to previously obtain phase shift and back-scattering amplitude described in Expression 2 for each shell. In the present application, a theoretical value of the Cr(OH)₃ structure was used since the feature of EXAFS analysis of a chromate film is very similar to that of Ref2 [Cr(OH)₃] reagent. However, since the crystal structure of Cr(OH)₃ is not yet clarified by this time, the crystal structure of Cr(OH)₃ was assumed to be the same type of structure as that of aluminum hydroxide, and the energetically most stable structure was estimated by the first principle calculation (applied code: CASTEP, manufactured by Accelrys, Inc.). In the present application, this is referred to as the “ab-initio structure”, and is shown in FIG. 2. Note that, in the calculation process, as the repulsion effect between d electrons of chromium should be incorporated, the repulsion effect was assumed to be U=2.5 eV, using so-called “U of Hubbard”. Further, with respect to phase shift and back-scattering amplitude described in Expression 2, the values obtained by theoretical estimation using a software FEFF8.40 available on the homepage of FEFF (http://leonardo.phys.washington.edu/feff/) were used. Furthermore, a cubic anharmonic term of thermal vibration was also taken into consideration in the EXAFS analysis.

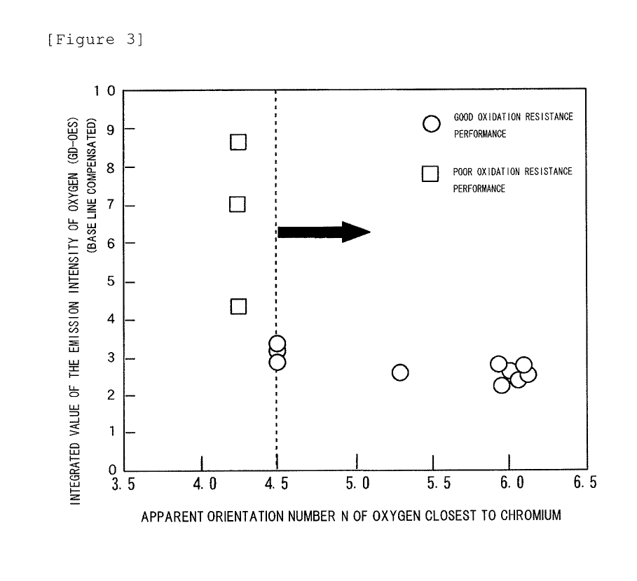

The “apparent orientation number N of oxygen closest to chromium” and the integrated value of the emission intensity of oxygen using GD-OES have a relationship as shown in FIG. 3. As shown in FIG. 3, the region having good oxidation resistance was judged a region where the apparent orientation number N of oxygen closest to chromium in a chromate film is 4.5 or more.

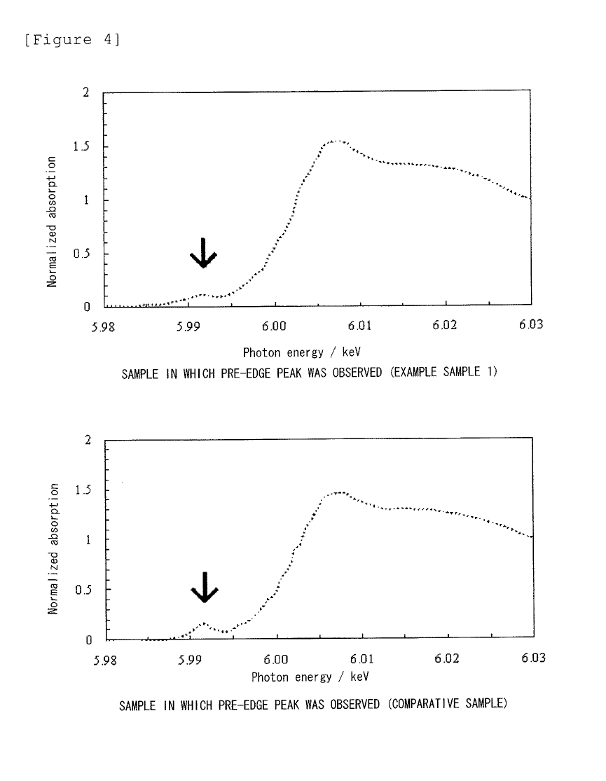

Normalized pre-edge peak of the chromate film: Further, in the copper foil provided with a chromate film for a negative electrode current collector according to the present application, the height of the normalized pre-edge peak in a XAFS spectrum is preferable to be 0.08 or less. When the height of the pre-edge peak is 0.08 or less, the oxidation resistance is stable. The words “height of the normalized pre-edge peak” described herein refer to the normalized intensity of the maximum absorption obtained through making the average intensity of chromium in the XAFS spectrum in the range of 40 eV to 100 eV from the K absorption end as 1 to normalize the peak height, and a base line is drawn at ±2 eV to the absorption maximum value between 5988 eV to 5996 eV. FIG. 4 shows the XAFS spectrum of a specimen in which the pre-edge was observed, and it is apparent that the pre-edge peak appears in the curve of Cr(OH)₃ at a position pointed by an arrow.

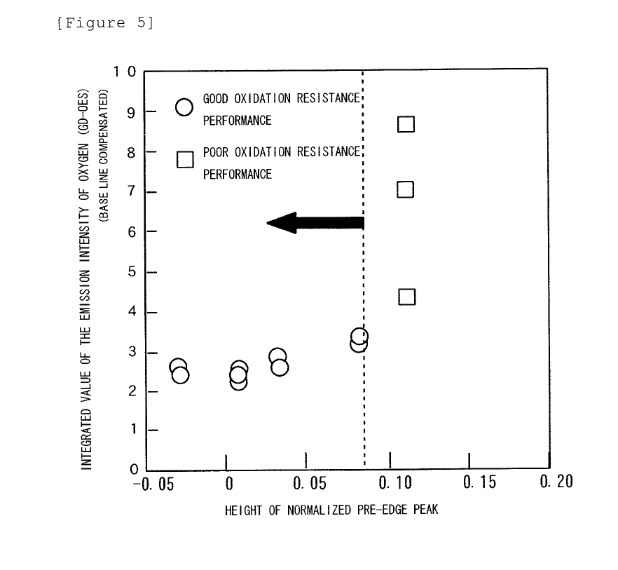

The “height of the normalized pre-edge peak” and the integrated value of the emission intensity of oxygen using GD-OES have a relationship as shown in FIG. 5. As shown in FIG. 5, the region having good oxidation resistance was judged a region where the height of the normalized pre-edge peak is 0.08 or less.

Further, in the copper foil provided with a chromate film for a negative electrode current collector according to the present application, thickness of the chromate film is preferable to be 1.0 mg/m² to 3.9 mg/m² as the deposition amount in terms of chromium. The thickness of the chromate film less than 1.0 mg/m² as the deposition amount in terms of chromium is not preferable because the oxidation resistance is hardly stabilized and the oxidation resistance fluctuates significantly. In contrast, the thickness of the chromate film exceeding 3.9 mg/m² as the deposition amount in terms of chromium is not preferable because the effect to improve oxidation resistance might be saturated; i.e. just waste of resources and only increase a production cost.

Method for manufacturing the copper foil provided with a chromate film for a negative electrode current collector: The copper foil provided with a chromate film for a negative electrode current collector according to the present application is preferable to be manufactured by applying chromate treatment to a copper foil surface by either an immersion method (immersion chromate treatment) or an electrolysis method (electrolytic chromate treatment) which will be described later. Hereinafter, a “pretreatment of copper foil” common in both treatment methods will be described, and then an “immersion chromate treatment” and an “electrolytic chromate treatment” will be described in this order.
Pretreatment of a copper foil: An excessive copper oxide exists on a copper foil surface makes formation of a chromate film difficult. Further, any contamination on a copper foil surface makes formation of a uniform and good chromate film impossible. Therefore, it is preferable to clean a copper foil surface and remove an oxide film naturally formed on the copper foil surface before carrying out chromate treatment to the copper foil. In the pretreatment, it is preferable to employ pickling treatment using a sulfuric acid solution, a hydrochloric acid solution, and the like. Note that, any of electro-deposited copper foil and rolled copper foil can be used as the copper foil in the present invention, but when rolled copper foil is used, it is preferable to degrease before the pickling treatment by using an alkaline solution such as a sodium hydroxide solution. This is because oily matter may remain on a surface of rolled copper foil, and the oily matter is preferable to be removed before applying chromate treatment. After finishing the pretreatment, it is preferable that the copper foil should be rinsed by water before chromate treatment. This is because a chromate-treatment solution deteriorates by an anion in the solution used for the pretreatment contaminated in the chromate-treatment solution. Note that for making sure, drying after water rinsing is not usually required.
Embodiments of immersion chromate treatment: The chromate-treatment solution used in immersion chromate treatment is an aqueous solution containing chromic acid. The chromium concentration of the chromate-treatment solution is preferable to be 0.3 g/L to 7.2 g/L, more preferable to be 0.3 g/L to 1.0 g/L. The chromium concentration of the chromate-treatment solution of less than 0.3 g/L is not preferable because the time required for chromate treatment should be prolonged and a chromate film formed may be formed in an island distribution. In contrast, with the chromium concentration exceeding 7.2 g/L, the chromate film obtained may be made thick, but the oxidation resistance may almost be saturated and not further improved.

PH of the chromate-treatment solution is preferable to be in the range of 1.8 to 7.0, more preferable to be in the range of 1.8 to 6.2, and further preferable to be in the range of 1.8 to 5.9. However, when pH of the chromate-treatment solution is more acidic less than 3.5, anions other than OH tend to contaminate into a chromate film to reduce the proportion of Cr(OH)₃, and the orientation number N might reduces also. Therefore, to further stabilize the chromate treatment, it is preferable to manage the lower limit of pH of the chromate-treatment solution to be 3.5. In contrast, when pH of the chromate-treatment solution is alkaline side exceeding 7.0, copper may contaminates into a chromate film to hinder generation of Cr(OH)₃ and the proportion of Cr(OH)₃ in a chromate film reduces, and the orientation number N might reduce also. Further, this pH range is not preferable because pre-edge peak is made large.

PH adjustment of the chromate-treatment solution is preferable to be carried out using chromium trioxide and sodium hydroxide as a pH adjuster. When pH adjustment is carried out using sulfuric acid or hydrochloric acid, formation of the chromate film by an immersion method might be made difficult. In addition, when pH adjusting component contaminates into a chromate film, the oxidation resistance might be reduced.

In the chromate-treatment solution, it is also preferable to take into consideration the relation between chromium and other anions exist together with the chromium. Particularly, it is preferable to satisfy the relationships, [S (mol/l)]/[Cr (mol/l)]<2 and [Cl (mol/l)]/[Cr (mol/l)]<0.5, in a molar ratio relative to chromium. Out of the molar ratio relationship is not preferable because the anions exist together with chromium may contaminate into a chromate film and oxidation resistance might be reduced.

The chromate-treatment solution used in the immersion method is preferable to be used at a solution temperature of 15° C. to 60° C. The solution temperature of less than 15° C. is not preferable because too long time may be required for chromate treatment not to satisfy the productivity required industrially. In contrast, the solution temperature exceeding 60° C. makes the reaction speed of chromate treatment rapid to make control of the reaction impossible, and may result uneven thickness in the chromate film. In addition, evaporation amount of water from the chromate-treatment solution may increase, and solution concentration may tend to fluctuate. Therefore, the solution temperature exceeding 60° C. is not preferable. When the stability of manufacturing is taken into consideration, the solution temperature is more preferable to be in the range of 25° C. to 45° C.

With respect to the immersion time in the immersion method, it is preferable to adopt a time of 0.5 second to 10 seconds. When the immersion time is less than 0.5 second, the method fails to form a uniform chromate film. In contrast, even if the immersion time exceeds 10 seconds, further improvement in the oxidation resistance depending on the increase in the thickness of the chromate film may not be achieved.

Embodiments of electrolytic chromate treatment: it is preferable to employ an electrolytic chromate treatment in comparison with immersion chromate treatment in advantages including less thickness deviation of a chromate film and stabile deposition amount. The concentration of chromium of the chromate-treatment solution used in electrolytic chromate treatment may be in the same concentration range as that of the chromate-treatment solution used in the immersion chromate treatment described above. Note that, the electrolytic conditions in performing electrolytic chromate treatment should not be limited. However, to uniformly provide a chromate film on a copper foil surface, it is preferable to immerse copper foil in a solution having a chromium concentration of 0.3 g/1 to 7.2 g/l and a pH of 10 to 13 and carry out electrolysis under the electrolytic condition of a current density of 0.1 A/dm² to 25 A/dm².

In the electrolytic chromate treatment, there is no particular limitation to pH of chromate solution. However in the electrolytic chromate treatment, pH of more acidic side less than 3.5 is not preferable also because chromium metal may be contaminated in a chromate film, and the proportion of Cr(OH)₃ might reduces and orientation number N might reduces also. Also with respect to pH adjustment of the chromate solution used in the electrolytic chromate treatment, the same concept as in the case of pH adjustment in the immersion method can be adopted.

It is preferable to adopt a current density of 0.1 A/dm² to 25 A/dm² for the electrolytic current in the electrolytic chromate treatment. The current density of less than 0.1 A/dm² is not preferable because a chromate film fails to have a uniform thickness. In contrast, as the current density exceeding 25 A/dm² remarkably generate hydrogen gas during the electrolysis, portion not treated might locally exists on a surface to be subjected to chromate treatment. In addition, the large heat generate during the electrolysis elevate the solution temperature. As a result, wrinkles tend to generate in the copper foil. Therefore, it is not preferable.

When the electrolytic chromate treatment is performed, the electrolysis time is preferable to be 0.5 second to 10 seconds. The electrolysis time of less than 0.5 second might fail to form a uniform chromate film. In contrast, even if the electrolysis time exceeds 10 seconds, the improvement in the oxidation resistance depending on the increase in the thickness of the chromate film might not be achieved. Therefore, prolonged electrolysis time is not preferable to result the waste of resources.

Note that the chromate-treatment solution used in the electrolytic chromate treatment is also preferable to be used at a solution temperature of 15° C. to 60° C. for the same reason as in the immersion chromate treatment. Further, when the stability of manufacturing is taken into consideration, the solution temperature is more preferable to be in the range of 25° C. to 45° C.

Negative electrode material: A negative electrode material of a lithium ion secondary battery according to the present application is characterized in that a negative electrode active material layer is provided on one surface or both surfaces of the copper foil provided with a chromate film for a negative electrode current collector according to any one described above. As the copper foil provided with a chromate film for a negative electrode current collector used for a negative electrode material of a lithium ion secondary battery according to the present application satisfies the conditions described above, less fluctuation in oxidation resistance hinders the oxidation of a copper foil surface very stably. As a result, when the copper foil provided with a chromate film for a negative electrode current collector according to the present invention is used for a current collector of the negative electrode material of a lithium ion secondary battery, amount of the oxide exists on the copper foil surface is made minimum, i.e. consumption of lithium in the lithium ion secondary battery in a charging process through reduction of oxide exists on the copper foil surface can be made to minimum. Therefore, decline in electric capacity of a lithium ion secondary battery can be effectively hindered.

### EXAMPLES

In the Examples, chromate treatment was applied to the copper foil surface by a method of either immersion chromate treatment or electrolytic chromate treatment to prepare Example Specimens 1 to 4. The conditions of each chromate treatment will be described.

Copper foil used: DFF (registered trademark) foil which is an electro-deposited copper foil manufactured by Mitsui Mining and Smelting Co., Ltd. was used.
Pretreatment of copper foil: Before applying chromate treatment to the surface of the electro-deposited copper foil, the surface of the electro-deposited copper foil was cleaned by pickling treatment. With respect to the pickling treatment conditions, a diluted sulfuric acid solution having a concentration of 100 g/l at a solution temperature of 30° C. was used, and the immersion time was 30 seconds. After immersing the electro-deposited copper foil in the diluted sulfuric acid solution, sufficient rinsing by water was carried out.
Immersion chromate treatment: Immersion chromate treatment was applied to the surface of the electro-deposited copper foil as follows. First, in preparation of Example Specimen 1, the conditions including a chromate-treatment solution having a chromium concentration of 0.6 g/l and a pH of 5.7 at a solution temperature of 40° C., a treatment time (immersing time) of 3.0 seconds, and water rinsing of the electro-deposited copper foil after immersing in the solution followed by drying was adopted. In preparation of Example Specimen 3, the conditions including a chromate-treatment solution having a chromium concentration of 1.6 g/l and a pH of 1.8 at a solution temperature of 25° C., a treatment time of 5.0 seconds, and water rinsing of the electro-deposited copper foil after immersing in the solution followed by drying was adopted. In preparation of Example Specimen 4, the conditions including a chromate-treatment solution having a chromium concentration of 0.3 g/l and a pH of 5.7 at a solution temperature of 40° C., a treatment time of 3.0 seconds, and drying without water rinsing was adopted. The electro-deposited copper foil provided with a chromate film on the surface by the immersion chromate treatments above were named as Example Specimen 1, Example Specimen 3, and Example Specimen 4, respectively. The production conditions of each specimen are summarized in Table 2.
Electrolytic chromate treatment: Electrolytic chromate treatment was applied to the surface of the electro-deposited copper foil as follows. First, electro-deposited copper foil immersed in a chromate-treatment solution having a chromium concentration of 3.6 g/l and a pH of 12.5 was electrolyzed under the conditions of a solution temperature of 40° C., a current density of 2.37 A/dm², and a treatment time (electrolysis time) of 1.5 seconds followed by water rinsing and drying. The electro-deposited copper foil provided with a chromate film on the surface by the electrolytic chromate treatment was named as Example Specimen 2. Production conditions are summarized in Table 2.

The matter was made apparent that in the chromate films of Example Specimen 1 to Example Specimen 4 prepared in this way include Cr(OH)₃ in high concentration and very small amount of Cr₂O₃ and CrO₃. Values of the apparent orientation number N of oxygen closest to chromium are rather higher. Further, the matter was made apparent that the heights of the normalized pre-edge peaks are rather lower.

### COMPARATIVE EXAMPLES

In the Comparative Example, the same copper foil as in Examples was used to perform the same pretreatment as in Examples to copper foil, and the immersion chromate treatment was then applied. The production conditions employed in Comparative Example differ only in the conditions of immersion chromate treatment. Therefore, only the immersion chromate treatment will be described. Note that production conditions are summarized in Table 2.

Immersion chromate treatment: In Comparative Example, the electro-deposited copper foil was subjected to immersion chromate treatment under the conditions including a solution having a chromium concentration of 0.6 g/l and a pH of 7.2 at a solution temperature of 40° C., a treatment time of 3 seconds, and drying without water rinsing on the electro-deposited copper foil. The electro-deposited copper foil provided with a chromate film on the surface by this immersion chromate treatment was named as Comparative Specimen.

The chromate film of Comparative Specimen obtained in this way includes a large amount of Cr₂O₃ and CrO₃ in addition to Cr(OH)₃. The matter was verified that the value of the apparent orientation number N of oxygen closest to chromium is rather lower. Further, it was apparent that the height of the normalized pre-edge peak was rather higher.

TABLE 2

| | Chromate treatment | | | | | |
|---|---|---|---|---|---|---|
| | | | Chromium | Solution | Current | |
| | Treatment | Solution | concentration | temperature | density | Treatment |
| Specimen | method | pH | (g/l) | (° C.) | (A/dm²) | time (sec) |
| Example | Immersion | 5.7 | 0.6 | 40 | — | 3.0 |
| Specimen 1 | method | | | | | |
| Example | Electrolysis | 12.5 | 3.6 | | 2.37 | 1.5 |
| Specimen 2 | method | | | | | |
| Example | Immersion | 1.8 | 1.6 | 25 | — | 5.0 |
| Specimen 3 | method | | | | | |
| Example | Immersion | 5.7 | 0.3 | 40 | | 3.0 |
| Specimen 4 | method | | | | | |
| Comparative | Immersion | 7.2 | 0.6 | 40 | — | 3.0 |
| Specimen | method | | | | | |

### [Evaluation of Oxidation Resistance]

In the present application, “oxidation resistance” was evaluated by the amount change of the oxide before and after subjecting a constant temperature/humidity test (at a temperature of 50° C. and a humidity of 95% RH) on the copper foil provided with a chromate film. Amount of the oxide on the surface of a copper foil provided with a chromate film can be determined through distribution analysis of elements in the depth direction of each specimen by GD-OES. Specifically, amount of the oxide on the surface of the copper foil provided with a chromate film was determined as follows. First, a profile of the emission intensity of oxygen in the depth direction of each specimen is measured by GD-OES. As described above, in the GD-OES, the surface of a specimen provided with a chromate film is etched by glow discharging in an argon gas atmosphere, and the spectrometry is performed concurrently with the etching. Therefore, at each predetermined time (for example, n seconds) passing after starting glow discharging, the chromate film provided on the surface of the specimen is etched, and the emission intensity of oxygen in the pure copper part (copper foil part) of the specimen is obtained. It is preferable to utilize the emission intensity of oxygen in the pure copper part as a basis for determining amount of the oxide on the surface of a copper foil provided with a chromate film. So, the average value of emission intensity of oxygen in a certain period of time (for example, for “a” seconds) following a predetermined time (for example, “n” seconds) after starting glow discharging was assumed as the average emission intensity of oxygen. Then, the average emission intensity is assumed as the emission intensity of oxygen in the pure copper part, and the average emission intensity of oxygen in the pure copper part (copper foil part) of the specimen was used as a standard (base line). Then, the value subtract the average emission intensity from the emission intensity of oxygen at each measuring time (glow discharging time), and the integrated emission intensity of oxygen during the period of time after starting glow discharging until (“n”+“a”) seconds passes (that is, between 0 second and (“n”+“a”) seconds) was used as amount of the oxide on the surface of a copper foil provided with a chromate film. That is, [integrated value of emission intensity of oxygen]=[amount of oxide]. Note that the time for reaching the pure copper part of a specimen differs depending on the etching rate based on glow discharging conditions, and the emission intensity of oxygen differs depending on the sensitivity of a detector. Based on the measurement conditions employed and the sensitivity of a detector in the present evaluation, a region in which the value 4.5 or less of the detected amount of oxide was judged to be a region without oxide.

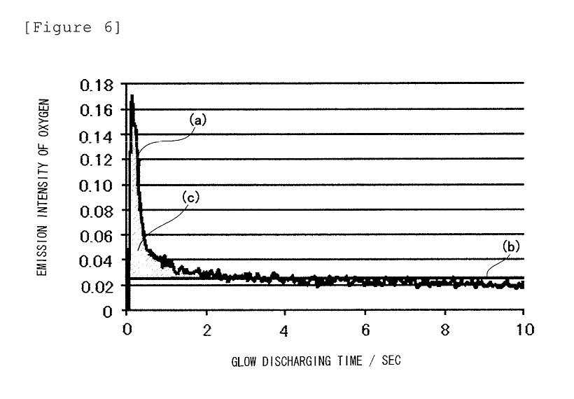

With reference to the actual measurement examples, the method to determine amount of the oxide based on the above GD-OES will be described more specifically. FIG. 6 shows an integrated value of emission intensity of oxygen when the profile in the depth direction of the emission intensity of oxygen of Example Specimen 2 was measured by GD-OES (see FIG. 6 (a)). The measurement conditions were as follows: output; 30 W, Ar gas pressure; 665 Pa, measurement mode; pulse method, frequency; 100 Hz, and duty; 0.25. Further, the etching rate was 32.5 nm (in terms of pure copper)/second. Furthermore, the average value of emission intensity used as a base line was assumed as the average emission intensity in 1 second (“a”=1) at 3 seconds (“n”=3) passing after starting glow discharging. That is, when each specimen is assumed to be a film composed of pure copper, the average value of the emission intensity in a depth of 97.5 nm (3 seconds) to 130 nm (4 seconds) from the surface of each specimen was used as the average emission intensity. The average emission intensity determined was used as a base line (see FIG. 6 (b)), and the average emission intensity ((b) in the figure) is subtracted from the emission intensity of oxygen ((a) in the figure) of Example Specimen 2 at each measuring time, and the emission intensity between 0 second to 4 seconds was integrated as shown in FIG. 6. Then, the integrated value (the region (c) shown by hatching surrounded by (a) and (b) in FIG. 6) was judged as amount of the oxide on the copper foil surface of Example Specimen 2.

TABLE 3

| | | | | Evaluation on oxidation resistance | | | |
|---|---|---|---|---|---|---|---|
| | Measured value of chromate film | | | | | Amount of | |
| | | Apparent | | | Amount of | oxide after | |
| | | orientation | Height of | Amount of oxide | oxide after | keeping in | |
| | Cr(OH)₃ | number N of | normalized | before constant | keeping in | 50° C. × 95% | |
| | content | oxygen | pre-edge | temperature/humidity | 50° C. × 95% | for 168 | Overall |
| Specimen | (area %) | closest to Cr | peak | test | for 48 hours | hours | evaluation |
| Example | 91 | 5.3 | 0.034 | 2.53382 | 2.56207 | 2.69056 | GOOD |
| Specimen 1 | | | | | | | |
| Example | 100 | 6.0 | 0.017 | 2.52702 | 2.73982 | 2.58466 | |
| Specimen 2 | | | | | | | |
| Example | 99 | 5.9 | −0.032 | 2.32935 | 2.53096 | 2.49974 | |
| Specimen 3 | | | | | | | |
| Example | 86 | 4.5 | 0.073 | 3.01251 | 3.22215 | 3.46337 | |
| Specimen 4 | | | | | | | |
| Comparative | 59 | 4.2 | 0.106 | 4.34818 | 8.56010 | 7.14454 | NOT GOOD |
| Specimen | | | | | | | |

### [Comparison Among Examples and Comparative Example]

Examples and Comparative Example will be compared with reference to Table 3. As apparent in Table 3, it is understood that amount of the oxide on the copper foil surface is smaller in all of Example Specimen 1 to Example Specimen 4 than that in Comparative Specimen even before the constant temperature/humidity test.

In Comparative Specimen, amounts of the oxide after the constant temperature/humidity test at 50° C. and 95% RH for both 48 hours and 168 hours greatly increase by 1.6 times to about twice as compared with amounts of the oxide before the constant temperature/humidity test. In contrast, in Example Specimen 1 to Example Specimen 4, amounts of the oxide after the constant temperature/humidity test at 50° C. and 95% RH for both 48 hours and 168 hours not significantly change as compared with amount of the oxide before the constant temperature/humidity test. From these results, it can be understood that the copper foil provided with a chromate film for a negative electrode current collector according to the present application is extremely excellent in oxidation resistance.

### INDUSTRIAL APPLICABILITY

As the copper foil provided with a chromate film for a negative electrode current collector according to the present application is provided with a chromate film excellent in oxidation resistance, amount of the oxide exists on the surface of copper foil can be made minimum. That is, in the lithium ion secondary battery in which the copper foil provided with a chromate film for a negative electrode current collector according to the present application is used for the negative electrode material, as amount of the oxide on the surface of copper foil used as a negative electrode material is made minimum, the consumption of lithium by the reduction of the oxide at the copper foil surface in a charging process can be hindered to be minimum, and decline in electric capacity is made minimum. So, a high quality lithium ion secondary battery can be supplied to the market.

1. A copper foil provided with a chromate film for a negative electrode current collector used as a negative electrode current collector of a lithium ion secondary battery, wherein chromium hydroxide constitutes 85 area % or more of the chromate film.

2. The copper foil provided with a chromate film for a negative electrode current collector according to claim 1, wherein an apparent orientation number N of oxygen closest to chromium in the chromate film obtained by XAFS analysis is 4.5 or more.

3. The copper foil provided with a chromate film for a negative electrode current collector according to claim 1, wherein a height of a normalized pre-edge peak of a chromium K absorption edge XAFS spectrum of the chromate film obtained by XAFS analysis is 0.08 or less.

4. The copper foil provided with a chromate film for a negative electrode current collector according to claim 1, wherein a deposition amount in terms of chromium in the chromate film is 1.0 mg/m² to 3.9 mg/m².

5. A negative electrode material of a lithium ion secondary battery, wherein a negative electrode active material layer is provided on one surface or both surfaces of a copper foil provided with a chromate film for a negative electrode current collector according to claim 1.

6. The copper foil provided with a chromate film for a negative electrode current collector according to claim 2, wherein a height of a normalized pre-edge peak of a chromium K absorption edge XAFS spectrum of the chromate film obtained by XAFS analysis is 0.08 or less.

7. The copper foil provided with a chromate film for a negative electrode current collector according to claim 2, wherein a deposition amount in terms of chromium in the chromate film is 1.0 mg/m² to 3.9 mg/m².

8. The copper foil provided with a chromate film for a negative electrode current collector according to claim 3, wherein a deposition amount in terms of chromium in the chromate film is 1.0 mg/m² to 3.9 mg/m².

9. The copper foil provided with a chromate film for a negative electrode current collector according to claim 6, wherein a deposition amount in terms of chromium in the chromate film is 1.0 mg/m² to 3.9 mg/m².

10. A negative electrode material of a lithium ion secondary battery, wherein a negative electrode active material layer is provided on one surface or both surfaces of a copper foil provided with a chromate film for a negative electrode current collector according to claim 2.

11. A negative electrode material of a lithium ion secondary battery, wherein a negative electrode active material layer is provided on one surface or both surfaces of a copper foil provided with a chromate film for a negative electrode current collector according to claim 3.

12. A negative electrode material of a lithium ion secondary battery, wherein a negative electrode active material layer is provided on one surface or both surfaces of a copper foil provided with a chromate film for a negative electrode current collector according to claim 4.

13. A negative electrode material of a lithium ion secondary battery, wherein a negative electrode active material layer is provided on one surface or both surfaces of a copper foil provided with a chromate film for a negative electrode current collector according to claim 6.

14. A negative electrode material of a lithium ion secondary battery, wherein a negative electrode active material layer is provided on one surface or both surfaces of a copper foil provided with a chromate film for a negative electrode current collector according to claim 7.

15. A negative electrode material of a lithium ion secondary battery, wherein a negative electrode active material layer is provided on one surface or both surfaces of a copper foil provided with a chromate film for a negative electrode current collector according to claim 8.

16. A negative electrode material of a lithium ion secondary battery, wherein a negative electrode active material layer is provided on one surface or both surfaces of a copper foil provided with a chromate film for a negative electrode current collector according to claim 9.
